(19) United States
(12) Patent Application Publication
(10) Pub. No.: US 2022/0034805 A1
(43) Pub. Date: Feb. 3, 2022

(54) IMAGING AN OBJECT THROUGH A SCATTERING MEDIUM

(71) Applicant: University Court of the University of St Andrews, St Andrews (GB)

(72) Inventors: Kishan Dholakia, Fife (GB); Mingzhou Chen, Fife (GB); Adria Escobet-Montalban, Fife (GB)

(73) Assignee: University Court of the University of St Andrews, St Andrews (GB)

(21) Appl. No.: 17/277,684

(22) PCT Filed: Sep. 17, 2019
(86) PCT No.: PCT/GB2019/052613

§ 371 Date: Mar. 18, 2021

(30) Foreign Application Priority Data
Sep. 20, 2018 (GB) PCT/GB2018/052684
Oct. 11, 2018 (GB) 1816606.6

(51) Int. Cl. G01N 21/47; G01N 21/64; G02B 21/00

(52) U.S. Cl. CPC G01N 21/4795; G02B 21/0076; G02B 21/0032; G01N 21/6458

(57) ABSTRACT

A method for use in imaging an object through a scattering medium comprises illuminating the object sequentially point-by-point through the scattering medium with incident electromagnetic radiation propagating along an illumination direction so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination direction so as to form spectrally dispersed electromagnetic radiation and by spatially focusing the spectrally dispersed electromagnetic radiation through the scattering medium to the object. The method comprises measuring, for each illuminated point of the object, a corresponding value representative of a quantity of at least a portion of the corresponding emitted electromagnetic radiation and using, for each illuminated point of the object, position information for the illuminated point and the corresponding measured value to determine an image of the object.

### FIELD

The present disclosure relates to a method and a system for use in imaging of an object through a scattering medium and, in particular though not exclusively, for imaging an object in the form of a sub-surface region of a sample through a scattering medium in the form of a scattering surface region of the same sample. The object and/or the scattering medium may comprise biological material, for example human or animal tissue. The method and system may be used for sheet imaging in vivo or in vitro.

### BACKGROUND

It is known to perform point-by-point imaging of a sample such as point-by-point multi-photon excitation fluorescence microscopy of a sample. For example, it is known to perform point-by-point multi-photon excitation fluorescence microscopy of biological material such as human or animal tissue in vivo or in vitro or to perform point-by-point multi-photon excitation fluorescence microscopy of at least one of: one or more cells, a colloid and an organism in vivo or in vitro. However, the quality of the image obtained using such imaging methods may deteriorate as a result of scattering in the sample with the result that such known point-by-point imaging methods and systems may not be able to image deep enough in the sample.

### SUMMARY

It should be understood that any one or more of the features of any of the following aspects or embodiments may be combined with any one or more of the features of any of the other aspects or embodiments.

According to at least one aspect or to at least one embodiment there is provided a method for use in imaging an object through a scattering medium, the method comprising:

illuminating the object sequentially point-by-point through the scattering medium with incident electromagnetic radiation propagating along an illumination direction so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination direction so as to form spectrally dispersed electromagnetic radiation and by spatially focusing the spectrally dispersed electromagnetic radiation through the scattering medium to the object;

measuring, for each illuminated point of the object, a corresponding value representative of a quantity of at least a portion of the corresponding emitted electromagnetic radiation; and

using, for each illuminated point of the object, position information for the illuminated point and the corresponding measured value to determine an image of the object.

The value representative of the quantity of at least a portion of the emitted electromagnetic radiation may comprise a power or intensity value of at least a portion of the emitted electromagnetic radiation. For example, the value representative of the quantity of at least a portion of the emitted electromagnetic radiation may comprise a relative or absolute power, or a relative or absolute intensity value, of at least a portion of the emitted electromagnetic radiation.

The method may comprise:

spectrally dispersing the initial electromagnetic radiation in the direction transverse to the illumination direction so as to form spectrally dispersed electromagnetic radiation; and

spatially focusing the spectrally dispersed electromagnetic radiation though the scattering medium to form the incident electromagnetic radiation in the object.

One of skill in the art will understand that the incident electromagnetic radiation may be formed by a form of spatio-temporal focusing. Such a point-by-point imaging method may enable point-by-point imaging of an object through a thicker scattering medium for a given degree of scattering and/or through a scattering medium formed from a material having a greater degree of scattering for a given thickness of scattering medium than known point-by-point imaging methods.

Illuminating the object sequentially point-by-point through the scattering medium with incident electromagnetic radiation may comprise illuminating different portions of the object sequentially, wherein each illuminated portion is a contiguous portion having a full-width at half maximum (FWHM) spatial extent or dimension of between 1 μm and 10 μm. For example, each illuminated portion may be a contiguous portion having a cross-sectional area in the range 1 μm²-100 μm² in a direction transverse to the illumination direction.

The method may comprise using the position information for each illuminated point of the object and the corresponding measured value to determine an image of the object without using a spatial distribution of the emitted electromagnetic radiation.

The method may comprise using the position information for each illuminated point of the object and the corresponding measured value to determine an image of the object without measuring the spatial distribution of the emitted electromagnetic radiation.

The method may comprise using the position information for each illuminated point of the object and the corresponding measured value to determine an image of the object without recording the spatial distribution of the emitted electromagnetic radiation.

The method may comprise measuring, for each illuminated point of the object, a corresponding value representative of a quantity of at least a portion of the corresponding emitted electromagnetic radiation using single pixel detection.

Measuring, for each illuminated point of the object, the corresponding value representative of the quantity of at least a portion of the emitted electromagnetic radiation may comprise using a single pixel detector to measure the power or the intensity of the emitted electromagnetic radiation which is incident on the single pixel detector.

Measuring, for each illuminated point of the object, the corresponding value representative of a quantity of at least a portion of the emitted electromagnetic radiation may comprise measuring, for each illuminated point of the object, the power or the intensity of the emitted electromagnetic radiation incident on a single pixel of a multi-pixel detector such as an image sensor.

Measuring, for each illuminated point of the object, the corresponding value representative of a quantity of at least a portion of the emitted electromagnetic radiation may comprise spatially integrating, for each illuminated point of the object, the power or the intensity of the emitted electromagnetic radiation incident on a plurality of the pixels of the multi-pixel detector.

Such a method may avoid any requirement to use an image sensor to sense the spatial distribution of the emitted electromagnetic radiation. Such a method may, therefore, provide an image of enhanced quality, for example improved contrast or improved signal to noise ratio, when imaging an object through a scattering medium compared with known imaging methods which rely upon the use of an image sensor.

The method may comprise determining the position information for each illuminated point of the object from a known configuration of an illumination arrangement used to illuminate the object.

The method may comprise:

illuminating one side of the object sequentially point-by-point through the scattering medium with the incident electromagnetic radiation; and

measuring, for each illuminated point of the object, the corresponding value representative of a quantity of at least a portion of the emitted electromagnetic radiation emitted from the same side of the object through the same scattering medium.

The method may comprise:

using a lens to illuminate the object with the incident electromagnetic radiation; and

using the same lens to collect at least a portion of the emitted electromagnetic radiation.

Illuminating the object sequentially point-by-point through the scattering medium with the incident electromagnetic radiation may comprise moving the incident electromagnetic radiation relative to the object and the scattering medium.

Moving the incident electromagnetic radiation relative to the object and the scattering medium may comprise:

sequentially spectrally dispersing different portions of a beam of initial electromagnetic radiation so as to sequentially form a plurality of corresponding spectrally dispersed beams of electromagnetic radiation; and

sequentially spatially focusing each spectrally dispersed beam of electromagnetic radiation to a corresponding point of the object through the scattering medium.

Moving the incident electromagnetic radiation relative to the object and the scattering medium may comprise:

sequentially directing the spectrally dispersed beam of electromagnetic radiation in a plurality of different directions so as to sequentially form a plurality of corresponding spectrally dispersed beams of electromagnetic radiation; and

sequentially spatially focusing each spectrally dispersed beam of electromagnetic radiation to a corresponding point of the object through the scattering medium.

Illuminating the object sequentially point-by-point through the scattering medium with the incident electromagnetic radiation may comprise moving the object and the scattering medium together relative to the incident electromagnetic radiation.

The method may comprise moving the sample and the scattering medium together along the illumination direction or in a direction opposite to the illumination direction relative to the incident electromagnetic radiation for volumetric imaging of the object.

The method may comprise varying the focal position of the incident electromagnetic radiation in the object along the illumination direction or in a direction opposite to the illumination direction for volumetric imaging of the object.

According to at least one aspect or to at least one embodiment there is provided a system for use in imaging an object through a scattering medium, the system comprising:

an illumination arrangement for illuminating the object sequentially point-by-point through the scattering medium with incident electromagnetic radiation propagating along an illumination direction so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination direction so as to form spectrally dispersed electromagnetic radiation and by spatially focusing the spectrally dispersed electromagnetic radiation through the scattering medium to the object;

a detection arrangement for measuring, for each illuminated point of the object, a corresponding value representative of a quantity of at least a portion of the corresponding emitted electromagnetic radiation; and

a processing resource configured to use, for each illuminated point of the object, position information for the illuminated point and the corresponding measured value to determine an image of the object.

The value representative of the quantity of at least a portion of the emitted electromagnetic radiation may comprise a power or intensity value of at least a portion of the emitted electromagnetic radiation. For example, the value representative of the quantity of at least a portion of the emitted electromagnetic radiation may comprise a relative or absolute power, or a relative or absolute intensity value, of at least a portion of the emitted electromagnetic radiation.

The illumination arrangement may comprise:

a spectrally dispersive element such as a diffraction grating for spectrally dispersing the initial electromagnetic radiation in the direction transverse to the illumination direction so as to form spectrally dispersed electromagnetic radiation; and

a spatial focusing arrangement located after the spectrally dispersive element for spatially focusing the spectrally dispersed electromagnetic radiation through the scattering medium to form the incident electromagnetic radiation in the object.

One of skill in the art will understand that the incident electromagnetic radiation may be formed by a form of spatio-temporal focusing. Such a point-by-point imaging system may enable point-by-point imaging of an object through a thicker scattering medium for a given degree of scattering and/or through a scattering medium formed from a material having a greater degree of scattering for a given thickness of scattering medium than known point-by-point imaging methods.

The illumination arrangement may be configured to illuminate different portions of the object sequentially, wherein each illuminated portion is a contiguous portion having a full-width at half maximum (FWHM) spatial extent or dimension of between 1 μm and 10 μm. For example, each illuminated portion may be a contiguous portion having a cross-sectional area in the range 1 μm²-100 μm² in a direction transverse to the illumination direction.

The processing resource may be configured to use the position information for each illuminated point of the object and the corresponding measured value to determine an image of the object without using a spatial distribution of the emitted electromagnetic radiation.

The processing resource may be configured to use the position information for each illuminated point of the object and the corresponding measured value to determine an image of the object without measuring the spatial distribution of the emitted electromagnetic radiation.

The processing resource may be configured to use the position information for each illuminated point of the object and the corresponding measured value to determine an image of the object without recording the spatial distribution of the emitted electromagnetic radiation.

The processing resource may be configured to determine the position information for each illuminated point of the object from a known configuration of the illumination arrangement.

The detection arrangement may be configured for single pixel detection.

The detection arrangement may comprise a single pixel detector for measuring the power or intensity of the emitted electromagnetic radiation incident on the single pixel detector.

The detection arrangement may comprise a single pixel detector of any kind. The single pixel detector may comprise a single pixel photodetector, a single pixel photodiode, a single pixel photomultiplier tube or the like.

The detection arrangement may comprise a multi-pixel detector having a plurality of pixels, for example an image sensor, wherein the detection arrangement is configured to:

measure the power or the intensity of the emitted electromagnetic radiation incident on a single pixel of the multi-pixel detector, or

spatially integrate the power or the intensity of the emitted electromagnetic radiation incident on a plurality of the pixels of the multi-pixel detector.

The system may comprise a spatial modulation arrangement located before the spectrally dispersive element for sequentially directing different portions of a beam of the initial electromagnetic radiation onto the spectrally dispersive element so as to sequentially form a plurality of corresponding spectrally dispersed beams of electromagnetic radiation. The spatial focusing arrangement may be configured to sequentially spatially focus each spectrally dispersed beam of electromagnetic radiation to the object so as to illuminate a corresponding point of the object through the scattering medium with the incident electromagnetic radiation.

Each portion of the beam of initial electromagnetic radiation may be a contiguous portion of the beam of initial electromagnetic radiation.

The spatial modulation arrangement may comprise a diffractive spatial modulation arrangement such as a spatial light modulator or may comprise a digital micro-mirror device.

The spatial modulation arrangement may comprise a plurality of elements for re-directing the beam of initial electromagnetic radiation incident upon the spatial modulation arrangement.

Each portion of the beam of initial electromagnetic radiation may be directed onto the spectrally dispersive element by a corresponding single element of the spatial modulation arrangement or by a corresponding group of contiguous elements of the spatial modulation arrangement.

The illumination arrangement may comprise a beam scanning arrangement located after the dispersive element for sequentially directing a beam of spectrally dispersed electromagnetic radiation in a plurality of different directions so as to sequentially form a plurality of corresponding spectrally dispersed beams of electromagnetic radiation. The spatial focusing arrangement may be configured to sequentially spatially focus each spectrally dispersed beam of electromagnetic radiation to the object so as to illuminate a corresponding point of the object through the scattering medium with the incident electromagnetic radiation.

The beam scanning arrangement may comprise one or more movable mirrors. Each movable mirror may comprise a scanning mirror, a tilting mirror or a galvanometric mirror.

The illumination arrangement may comprise a collimating arrangement located between the dispersive element and the beam scanning arrangement for collimating the beam of spectrally dispersed electromagnetic radiation before the beam of spectrally dispersed electromagnetic radiation is incident on the beam scanning arrangement.

The collimating arrangement may be configured to collimate the beam of spectrally dispersed electromagnetic radiation in the same transverse direction in which the dispersive element spectrally disperses the initial electromagnetic radiation so as to form a collimated sheet of spectrally dispersed electromagnetic radiation.

The collimating arrangement may comprise a second spectrally dispersive element such as a second diffraction grating. The collimating arrangement may comprise a cylindrical collimating lens or a cylindrical collimating mirror.

The illumination arrangement may comprise a third spectrally dispersive element, such as a third diffraction grating, located between the collimating arrangement and the beam scanning arrangement for spectrally dispersing the collimated sheet of spectrally dispersed electromagnetic radiation in a second transverse direction which is orthogonal to the transverse direction in which the spectrally dispersive element spectrally disperses the initial electromagnetic radiation. The illumination arrangement may comprise a further collimating arrangement located between the third spectrally dispersive element and the beam scanning arrangement for collimating the resulting spectrally dispersed electromagnetic radiation in the second transverse direction so as to form a beam of spectrally dispersed electromagnetic radiation which is spectrally dispersed in two transverse orthogonal directions.

The further collimating arrangement may comprise a fourth spectrally dispersive element such as a fourth diffraction grating. The further collimating arrangement may comprise a further cylindrical collimating lens or a further cylindrical collimating mirror.

The illumination arrangement may comprise an isotropic spectrally dispersive element, such as a circular diffraction grating, for spectrally dispersing the beam of initial electromagnetic radiation isotropically in a dispersion cone.

The system may comprise a translation stage for moving the object and the scattering medium together relative to the incident electromagnetic radiation in a direction transverse to the illumination direction.

The illumination arrangement may be configured to illuminate one side of the object through the scattering medium, and wherein the detection arrangement is configured to measure the value representative of the quantity of at least a portion of the emitted electromagnetic radiation emitted from the same side of the object through the same scattering medium.

The system may comprise a lens, such as a microscope objective, configured to illuminate the object, wherein the same lens is configured to collect at least a portion of the emitted electromagnetic radiation emitted from the object through the same scattering medium.

The illumination arrangement may comprise a source of electromagnetic radiation for generating the initial electromagnetic radiation. The source of electromagnetic radiation may be coherent. The source of electromagnetic radiation may be tunable. The source of electromagnetic radiation may comprise a laser. The source of electromagnetic radiation may comprise an optical parametric oscillator (OPO). The source of electromagnetic radiation may be configured to generate pulses of electromagnetic radiation such as ultrashort pulses of electromagnetic radiation. The use of pulsed electromagnetic radiation may provide the initial electromagnetic radiation with a predetermined spectral bandwidth which may facilitate spectral dispersion of the initial electromagnetic radiation.

The pulses of electromagnetic radiation may be unchirped. The pulses of electromagnetic radiation may be transform-limited. The pulses of electromagnetic radiation may be chirped.

The illumination arrangement may be configured to scan the incident electromagnetic radiation over a field of view in the object of less than 500×500 μm², of less than 50×50 μm², or of approximately 10×10 μm².

The system may comprise a translation stage for moving the object and the scattering medium together along the illumination direction or in a direction opposite to the illumination direction relative to the incident electromagnetic radiation for volumetric imaging of the object.

The system may comprise a tunable focusing element such as a tunable focusing lens for varying the focal position of the incident electromagnetic radiation in the object along the illumination direction or in a direction opposite to the illumination direction for volumetric imaging of the object.

The system may be configured for microscopy.

The system may be configured for use with a microscope.

The system may comprise a microscope.

The object may be formed separately from the scattering medium.

The object may comprise a sub-surface region of a sample and the scattering medium may comprise a scattering surface region of the same sample. The sub-surface region of the sample may comprise an extended region of the sample, for example a 2D region of the sample such as a plane, or a 3D region of the sample.

The scattering medium may be time-varying. For example, the scattering medium may comprise, or be, a turbulent fluid.

The scattering medium may be fluorescent.

The object may be a non-scattering object.

The object may be a scattering object.

The object may be time-varying. For example, the object may comprise, or be, a turbulent fluid.

The object may be fluorescent.

The object may comprise one or more exogenous fluorophores such as a green fluorescent protein (GFP) or a red fluorescent protein (RFP).

The object may comprise one or more endogenous fluorophores such as NADH and/or flavins.

The object may scatter the incident electromagnetic radiation and/or the emitted electromagnetic radiation generated in the object.

The object and/or the scattering medium may comprise biological material. The object and/or the scattering medium may comprise human or animal tissue. The object and/or the scattering medium may comprise at least one of: one or more cells, a colloid and an organism. The object and/or the scattering medium may be alive or dead.

The initial electromagnetic radiation may be coherent.

The initial electromagnetic radiation may be pulsed. For example, the initial electromagnetic radiation may be provided in pulses such as ultrashort pulses. The use of pulsed electromagnetic radiation may provide the initial electromagnetic radiation with a predetermined spectral bandwidth which may facilitate spectral dispersion of the initial electromagnetic radiation.

The pulses of electromagnetic radiation may be unchirped. The pulses of electromagnetic radiation may be transform-limited.

The pulses of electromagnetic radiation may be chirped.

The incident electromagnetic radiation and the emitted electromagnetic radiation may have different spectra and/or one or more different wavelengths.

The incident electromagnetic radiation may comprise light, for example infrared, visible or UV light.

The emitted electromagnetic radiation may comprise light, for example infrared, visible or UV light.

The emitted electromagnetic radiation may comprise THz radiation.

The emitted electromagnetic radiation may comprise fluorescence generated by the object as a result of excitation of the object by the incident electromagnetic radiation.

The incident electromagnetic radiation may be configured for multi-photon excitation of the object. For example, the incident electromagnetic radiation may include an appropriate wavelength or range of wavelengths for multi-photon excitation of the object.

The incident electromagnetic radiation may be configured for two-photon excitation of the object. For example, the incident electromagnetic radiation may include an appropriate wavelength or range of wavelengths for two-photon excitation of the object. The incident electromagnetic radiation may include a wavelength in the range of 700 nm to 950 nm.

The incident electromagnetic radiation may be configured for three-photon excitation of the object. For example, the incident electromagnetic radiation may include an appropriate wavelength or range of wavelengths for three-photon excitation of object. The incident electromagnetic radiation may include a wavelength in the range of 1,300 nm to 1,700 nm.

The emitted electromagnetic radiation may be generated by the object as a result of a non-linear optical interaction between the incident electromagnetic radiation and the object.

The emitted electromagnetic radiation may comprise a harmonic of the incident electromagnetic radiation, such as a second harmonic of the incident electromagnetic radiation or a third harmonic of the incident electromagnetic radiation.

The emitted electromagnetic radiation may be generated by the object as a result of inelastic scattering of the incident electromagnetic radiation in the object.

The emitted electromagnetic radiation may be generated by the object as a result of Raman scattering of the incident electromagnetic radiation in the object.

The emitted electromagnetic radiation may be generated by the object as a result of coherent or stimulated Raman scattering of the incident electromagnetic radiation in the object.

The emitted electromagnetic radiation may be generated by the object as a result of Coherent Anti-Stokes Raman Scattering (CARS) in the object.

The incident electromagnetic radiation may comprise a stream of pulses of electromagnetic radiation.

Each pulse of the incident electromagnetic radiation may have a duration of 1 ps or less, 500 fs or less, 100-200 fs, or 10-100 fs.

The incident electromagnetic radiation may have an average power in the range 100-1,000 mW, 10 mW-100 mW or 1 mW-10 mW.

### BRIEF DESCRIPTION OF THE DRAWINGS

A method and a system for use in imaging an object through a scattering medium will now be described by way of non-limiting example only with reference to the drawings of which:

FIG. 1 shows a system or use in imaging an object through a scattering medium; and

FIG. 2 shows an alternative system or use in imaging an object through a scattering medium.

### DETAILED DESCRIPTION OF THE DRAWINGS

One of skill in the art will understand that one or more of the features of the embodiments described below with reference to the drawings may produce effects or provide advantages when used in isolation from one or more of the other features of the embodiments and that different combinations of the features are possible other than the specific combinations of the features of the embodiments described below.

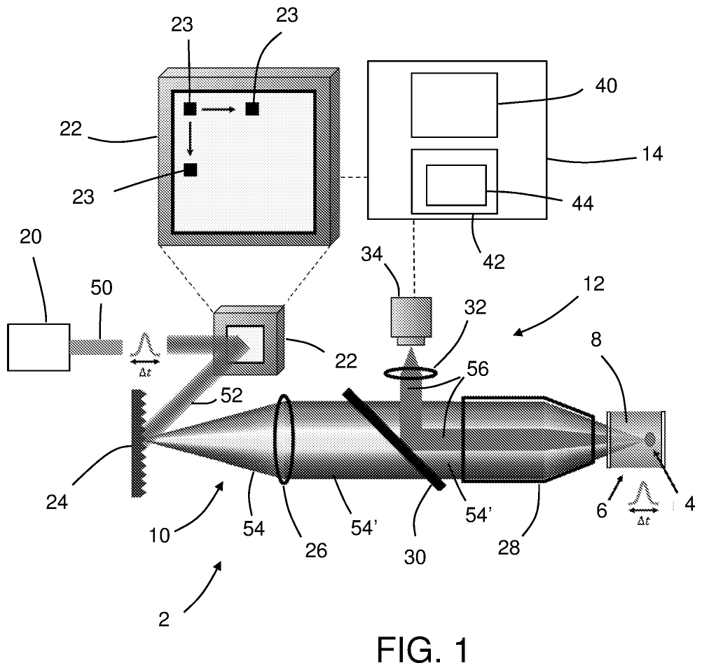

Referring initially to FIG. 1 there is shown an imaging system in the form of a multi-photon excitation fluorescence imaging system generally designated 2 for use in imaging a fluorescent object in the form of a fluorescent sub-surface region 4 of a sample, generally designated 6, through a scattering medium in the form of a scattering surface region 8 of the sample 6.

The imaging system 2 includes an illumination arrangement generally designated 10 for illuminating the fluorescent sub-surface region 4 of the sample 6, a detection arrangement generally designated 12 for measuring the corresponding electromagnetic radiation in the form of the corresponding fluorescence emitted from the fluorescent sub-surface region 4 of the sample 6, and a processing resource generally designated 14.

The illumination arrangement 10 includes a source of initial electromagnetic radiation in the form of a pulsed laser 20, a spatial modulation arrangement in the form of a spatial light modulator 22, a spectrally dispersive element in the form of a diffraction grating 24, a collimating lens 26 and a microscope objective lens 28. The collimating lens 26 and the microscope objective lens 28 are arranged so as to illuminate the fluorescent sub-surface region 4 of the sample 6 along an illumination direction. The diffraction grating 24 is arranged so as to spectrally disperse the initial electromagnetic radiation in a direction transverse to the illumination direction.

As will be appreciated by one of ordinary skill in the art, FIG. 1 shows two views of the spatial light modulator 22: a first view of the spatial light modulator 22 “in situ” receiving light from the pulsed laser 20 and directing the received light towards the diffraction grating 24; and a second, more detailed, view of the spatial light modulator 22 illustrating the operation of the spatial light modulator 22 as described in more detail below. As shown in the second, more detailed, view of the spatial light modulator 22, the spatial light modulator 22 comprises a plurality of optical elements 23 wherein each optical element 23 is capable of redirecting light incident on the optical element 23 in a desired direction independently of any of the other optical elements 23.

The detection arrangement 12 includes the microscope objective lens 28, a dichroic mirror 30, a focusing lens 32 and a single pixel detector 34.

The processing resource 14 includes a processor 40 and a memory 42. The memory 42 stores a computer program 44. The processing resource 14 is configured for communication with the spatial light modulator 22 and the single pixel detector 34.

In use, the pulsed laser 20 generates initial electromagnetic radiation in the form of a beam 50 of ultrashort laser pulses, for example unchirped or approximately transform-limited laser pulses having a duration Δt of 140 fs, at a wavelength of 800 nm and a repetition rate of 80 MHz. When executed by the processor 40, the computer program 44 causes the processing resource 14 to control the optical elements 23 of the spatial light modulator 22 so as to sequentially direct different portions 52 of the beam 50 towards the diffraction grating 24. Specifically, the computer program 44 causes a first one of the optical elements 23 (or a first plurality of contiguous optical elements 23) to direct a corresponding first portion 52 of the beam 50 towards the diffraction grating 24 at a first time, a second one of the optical elements 23 (or a second plurality of contiguous optical elements 23) to direct a corresponding second portion 52 of the beam 50 towards the diffraction grating 24 at a second time, etc.

The diffraction grating 24 spectrally disperses each portion of the beam 50 in a direction transverse to the illumination direction one at a time so as to form spectrally dispersed electromagnetic radiation in the form of a different spectrally dispersed beam 54 corresponding to each portion of the beam 50. Each spectrally dispersed beam 54 is collimated by the collimating lens 26 so as to form a corresponding collimated beam 54′ of spectrally dispersed electromagnetic radiation. Each collimated beam 54′ of spectrally dispersed electromagnetic radiation is spatially focused by the microscope objective lens 28 along the illumination direction through the scattering surface region 8 of the sample 6 onto the fluorescent sub-surface region 4 of the sample 6 to a contiguous portion of the fluorescent sub-surface region 4 of the sample 6 having a full-width at half maximum (FWHM) spatial extent or dimension of between 1 μm and 10 μm. For example, the contiguous portion may have a cross-sectional area in the range 1 μm²-100 μm² in a direction transverse to the illumination direction.

The computer program 44 causes the processing resource 14 to control the optical elements 23 of the spatial light modulator 22 so as to sequentially illuminate the fluorescent sub-surface region 4 of the sample 6 point-by-point through the scattering surface region 8 of the sample 6 with incident electromagnetic radiation along the illumination direction. From the foregoing description, one of ordinary skill in the art will understand that spectrally dispersing the portion of the beam 50 of initial electromagnetic radiation in a direction transverse to the illumination direction so as to form a beam 54 of spectrally dispersed electromagnetic radiation and then collimating and spatially focusing the beam 54 of spectrally dispersed electromagnetic radiation along the illumination direction so as to illuminate the fluorescent sub-surface region 4 of the sample 6 through the scattering surface region 8 of the sample 6 with the incident electromagnetic radiation, constitutes a form of spatio-temporal focusing for enhanced penetration of the incident electromagnetic radiation along the illumination direction.

The incident electromagnetic radiation interacts with the fluorescent sub-surface region 4 of the sample 6 to cause the fluorescent sub-surface region 4 of the sample 6 to emit electromagnetic radiation in the form of fluorescence 56. A portion of the fluorescence 56 propagates back through the scattering surface region 8 of the sample 6 and is collected by the microscope objective lens 28. The dichroic mirror 30 re-directs the collected fluorescence 56 through 90°, whereupon the focusing lens 32 focuses the collected fluorescence 56 onto the single pixel detector 34. The single pixel detector 34 measures, for each illuminated point of the fluorescent sub-surface region 4 of the sample 6, a corresponding value representative of a quantity of at least a portion of the collected fluorescence 56. Specifically, the single pixel detector 34 measures, for each illuminated point of the fluorescent sub-surface region 4 of the sample 6, the power of the collected fluorescence 56 which is incident on the single pixel detector 34. When executed by the processor 40, the computer program 44 causes the processor 40 to determine position information for each illuminated point of the fluorescent sub-surface region 4 of the sample 6 from a known configuration (e.g. the known geometry) of the illumination arrangement 10. When executed by the processor 40, the computer program 44 causes the processor 40 to use the determined position information for each illuminated point of the fluorescent sub-surface region 4 of the sample 6 and the corresponding measured power values to determine an image of the fluorescent sub-surface region 4 of the sample 6.

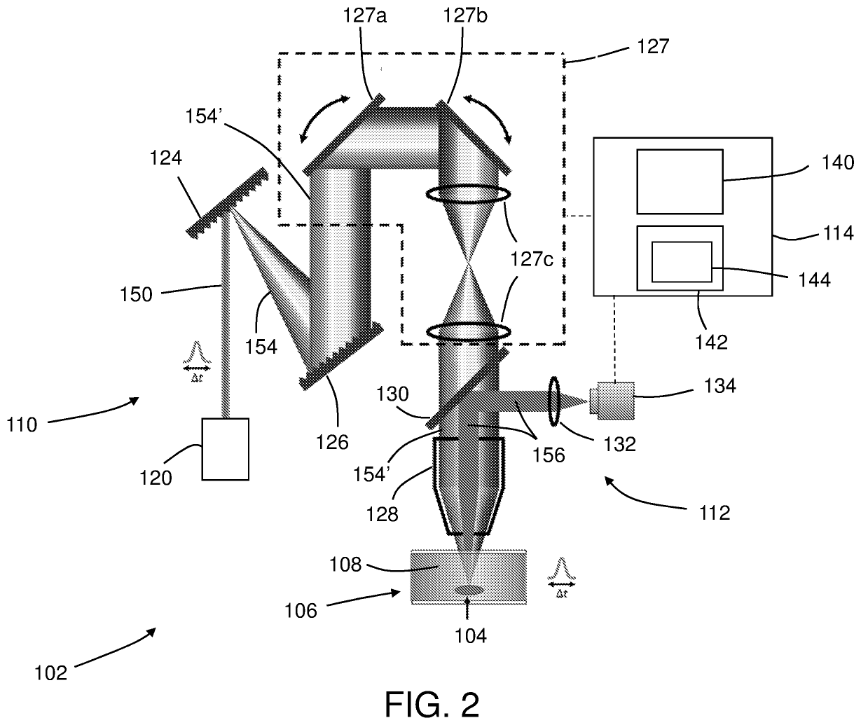

Referring to FIG. 2 there is shown an alternative imaging system in the form of a multi-photon excitation fluorescence imaging system generally designated 102 for use in imaging a fluorescent object in the form of a fluorescent sub-surface region 104 of a sample, generally designated 106, through a scattering medium in the form of a scattering surface region 108 of the sample 106.

The imaging system 102 includes an illumination arrangement generally designated 110 for illuminating the fluorescent sub-surface region 104 of the sample 106, a detection arrangement generally designated 112 for measuring the corresponding electromagnetic radiation in the form of the corresponding fluorescence emitted from the fluorescent sub-surface region 104 of the sample 106, and a processing resource generally designated 114.

The illumination arrangement 110 includes a source of initial electromagnetic radiation in the form of a pulsed laser 120, a spectrally dispersive element in the form of a diffraction grating 124, a further spectrally dispersive element in the form of a further diffraction grating 126, a beam scanning arrangement in the form of an XY scanning module 127, and a microscope objective lens 128. The XY scanning module 127 includes first and second galvanometric mirrors 127a and 127b respectively, and a coupling lens arrangement 127c for coupling electromagnetic radiation from the XY scanning module 127 to the microscope objective lens 128. The microscope objective lens 128 is arranged so as to illuminate the fluorescent sub-surface region 104 of the sample 106 along an illumination direction. The diffraction grating 124 is arranged so as to spectrally disperse the initial electromagnetic radiation in a direction transverse to the illumination direction so as to form spectrally dispersed electromagnetic radiation. The further diffraction grating 126 is arranged so as to collimate the spectrally dispersed electromagnetic radiation in the same direction transverse to the illumination direction in which the diffraction grating 124 spectrally disperses the initial electromagnetic radiation.

The detection arrangement 112 includes the microscope objective lens 128, a dichroic mirror 130, a focusing lens 132 and a single pixel detector 134.

The processing resource 114 includes a processor 140 and a memory 142. The memory 142 stores a computer program 144. The processing resource 114 is configured for communication with the XY scanning module 127 and the single pixel detector 134.

In use, the pulsed laser 120 generates initial electromagnetic radiation in the form of a beam 150 of ultrashort laser pulses, for example unchirped or approximately transform-limited laser pulses having a duration Δt of 140 fs, at a wavelength of 800 nm and a repetition rate of 80 MHz. The beam 150 of ultrashort laser pulses is directed onto the diffraction grating 124 which spectrally disperses the beam 150 in the transverse direction so as to form a spectrally dispersed beam 154. The further diffraction grating 126 collimates the spectrally dispersed beam 154 in the same transverse direction in which the beam of initial electromagnetic radiation 150 is spectrally dispersed by the diffraction grating 124 so as to form a collimated spectrally dispersed beam of electromagnetic radiation 154′. The further diffraction grating 126 directs the collimated spectrally dispersed beam of electromagnetic radiation 154′ towards the first galvanometric mirror 127a of the XY scanning module 127. The first galvanometric mirror 127a reflects the collimated spectrally dispersed beam 154′ towards the second galvanometric mirror 127b of the XY scanning module 127. The second galvanometric mirror 127b reflects the collimated spectrally dispersed beam 154′ towards the coupling lens arrangement 127c which couples the collimated spectrally dispersed beam 154′ to the back focal plane of the microscope objective 128. The microscope objective lens 128 images the collimated spectrally dispersed beam 154′ through the scattering surface region 108 of the sample 106 to a point of the fluorescent sub-surface region 104 of the sample 106, wherein the position of the point is determined by the direction of incidence of the collimated spectrally dispersed beam 154′ in relation to the microscope objective 128. Specifically, the microscope objective lens 128 images the collimated spectrally dispersed beam 154′ through the scattering surface region 108 of the sample 106 to a contiguous portion of the fluorescent sub-surface region 104 of the sample 106 having a full-width at half maximum (FWHM) spatial extent or dimension of between 1 μm and 10 μm. For example, the contiguous portion may have a cross-sectional area in the range 1 μm²-100 μm² in a direction transverse to the illumination direction.

When executed by the processor 140, the computer program 144 causes the processing resource 114 to control the XY scanning module 127 so as to sequentially generate a plurality of collimated spectrally dispersed beams 154′ one at a time, each collimated spectrally dispersed beam 154′ being generated along a different direction of incidence on the microscope objective 128.

The computer program 144 causes the processing resource 114 to control the XY scanning module 127 so as to sequentially illuminate the fluorescent sub-surface region 104 of the sample 106 point-by-point through the scattering surface region 108 of the sample 106 with temporally focused electromagnetic radiation. From the foregoing description, one of ordinary skill in the art will understand that spectrally dispersing the beam 150 of initial electromagnetic radiation in a direction transverse to the illumination direction so as to form a beam 154 of spectrally dispersed electromagnetic radiation and then collimating and spatially focusing the beam 154 of spectrally dispersed electromagnetic radiation along the illumination direction so as to illuminate the fluorescent sub-surface region 104 of the sample 106 through the scattering surface region 108 of the sample 106 with the incident electromagnetic radiation, constitutes a form of spatio-temporal focusing for enhanced penetration of the incident electromagnetic radiation along the illumination direction.

The incident electromagnetic radiation interacts with the fluorescent sub-surface region 104 of the sample 106 to cause the fluorescent sub-surface region 104 of the sample 106 to emit electromagnetic radiation in the form of fluorescence 156. A portion of the fluorescence 156 propagates back through the scattering surface region 108 of the sample 106 and is collected by the microscope objective lens 128. The dichroic mirror 130 re-directs the collected fluorescence 156 through 90°, whereupon the focusing lens 132 focuses the collected fluorescence 156 onto the single pixel detector 134. The single pixel detector 134 measures, for each illuminated point of the fluorescent sub-surface region 104 of the sample 106, a corresponding value representative of a quantity of at least a portion of the collected fluorescence 156. Specifically, the single pixel detector 134 measures, for each illuminated point of the fluorescent sub-surface region 104 of the sample 106, the power of the collected fluorescence 156 which is incident on the single pixel detector 134. When executed by the processor 140, the computer program 144 causes the processor 140 to determine position information for each illuminated point of the fluorescent sub-surface region 104 of the sample 106 from a known configuration (e.g. the known geometry) of the illumination arrangement 110. When executed by the processor 140, the computer program 144 causes the processor 140 to use the determined position information for each illuminated point of the fluorescent sub-surface region 104 of the sample 106 and the corresponding measured power values to determine an image of the fluorescent sub-surface region 104 of the sample 106.

It will be appreciated by one skilled in the art that various modifications may be made to the foregoing methods and systems without departing from the scope of the present invention as defined by the claims. For example, rather than using a spatial light modulator 22, the spatial modulation arrangement may comprise a digital micromirror device (DMD).

The detector arrangement may comprise a single pixel detector of any kind. The single pixel detector may be configured to measure the power or the intensity of the emitted electromagnetic radiation incident on the single-pixel detector. The single pixel detector may comprise a single pixel photodetector, a single pixel photodiode, a single pixel photomultiplier tube or the like.

The detector arrangement may comprise a single pixel detection arrangement of any kind. For example, rather than comprising a single pixel detector, the detection arrangement may comprise a multi-pixel detector having a plurality of pixels, for example an image sensor, wherein the detection arrangement is configured to measure the power or the intensity of the emitted electromagnetic radiation incident on a single pixel of the multi-pixel detector. Alternatively, rather than comprising a single pixel detector, the detection arrangement may comprise a multi-pixel detector having a plurality of pixels, for example an image sensor, wherein the detection arrangement is configured to spatially integrate the power or the intensity of the emitted electromagnetic radiation incident on a plurality of the pixels of the multi-pixel detector.

The XY scanning module 127 of FIG. 2 may be replaced by a beam scanning arrangement of any kind. The beam scanning arrangement may comprise more or fewer than two mirrors. Rather than using galvanometric mirrors, the beam scanning arrangement may comprise one or more movable mirrors of any kind. For example, each movable mirror may comprise a scanning mirror or a tilting mirror.

Rather than using a further dispersive element in the form of the further diffraction grating 126 to collimate the spectrally dispersed beam 154 in the same transverse direction in which the beam of initial electromagnetic radiation 150 is spectrally dispersed by the diffraction grating 124 so as to form the collimated spectrally dispersed beam of electromagnetic radiation 154′, the illumination arrangement may comprise a collimating arrangement of any kind located between the diffraction grating 124 and the beam scanning arrangement 127 for collimating the beam of spectrally dispersed electromagnetic radiation 154 in the same transverse direction in which the beam of initial electromagnetic radiation 150 is spectrally dispersed so as to form the spectrally dispersed beam of electromagnetic radiation 154′. For example, the collimating arrangement may comprise a cylindrical collimating lens or a cylindrical collimating mirror. The illumination arrangement may comprise a third spectrally dispersive element (not shown), such as a third diffraction grating, located between the collimating arrangement 126 and the beam scanning arrangement 127 for spectrally dispersing the collimated beam of spectrally dispersed electromagnetic radiation 154′ in a second transverse direction which is orthogonal to the transverse direction in which the spectrally dispersive element 124 spectrally disperses the beam of initial electromagnetic radiation 150. The illumination arrangement may comprise a further collimating arrangement (not shown) located between the third spectrally dispersive element and the beam scanning arrangement 127 for collimating the resulting spectrally dispersed electromagnetic radiation in the second transverse direction so as to form a beam of electromagnetic radiation which is spectrally dispersed in two orthogonal transverse directions.

The further collimating arrangement (not shown) may comprise a fourth spectrally dispersive element such as a fourth diffraction grating. The further collimating arrangement may comprise a further cylindrical collimating lens or a further cylindrical collimating mirror.

In a further variant, rather than using two separate spectrally dispersive elements to separately spectrally disperse the beam of initial electromagnetic radiation in two orthogonal transverse directions, the illumination arrangement may comprise an isotropic spectrally dispersive element, such as a circular diffraction grating, for spectrally dispersing the beam of initial electromagnetic radiation isotropically in a dispersion cone.

The imaging system may comprise a translation stage for moving the object and the scattering medium together relative to the incident electromagnetic radiation in a direction transverse to the illumination direction.

The system may comprise a translation stage for moving the object and the scattering medium together along the illumination direction or in a direction opposite to the illumination direction relative to the incident electromagnetic radiation for volumetric imaging of the object.

The system may comprise a tunable focusing element such as a tunable focusing lens for varying the focal position of the incident electromagnetic radiation in the object along the illumination direction or in a direction opposite to the illumination direction for volumetric imaging of the object.

The source of electromagnetic radiation may be coherent. The source of electromagnetic radiation may be tunable. The source of electromagnetic radiation may comprise an optical parametric oscillator (OPO). The source of electromagnetic radiation may be configured to generate pulses of electromagnetic radiation such as ultrashort pulses of electromagnetic radiation.

The pulses of electromagnetic radiation may be unchirped. The pulses of electromagnetic radiation may be transform-limited. The pulses of electromagnetic radiation may be chirped.

The illumination arrangement may be configured to scan the electromagnetic radiation over a field of view in the object of less than 500×500 μm², of less than 50×50 μm², or of approximately 10×10 μm².

The imaging system may be configured for microscopy.

The imaging system may be configured for use with a microscope.

The imaging system may comprise a microscope.

Although the object is described above as a sub-surface region of a sample and the scattering medium is described above as a scattering surface region of the same sample, the object may be formed separately from the scattering medium.

The sub-surface region of the sample may comprise an extended region of the sample, for example a 2D region of the sample such as a plane, or a 3D region of the sample.

The scattering medium may be time-varying. For example, the scattering medium may comprise, or be, a turbulent fluid.

The scattering medium may be fluorescent.

The object may comprise one or more exogenous fluorophores such as a green fluorescent protein (GFP) or a red fluorescent protein (RFP).

The object may comprise one or more endogenous fluorophores such as NADH and/or flavins.

The object may be a non-scattering object.

The object may be a scattering object.

The object may be time-varying. For example, the object may comprise, or be, a turbulent fluid.

The object may scatter the incident electromagnetic radiation and/or the emitted electromagnetic radiation generated in the object.

The object and/or the scattering medium may comprise biological material. The object and/or the scattering medium may comprise human or animal tissue. The object and/or the scattering medium may comprise at least one of: one or more cells, a colloid and an organism. The object and/or the scattering medium may be alive or dead.

The initial electromagnetic radiation may be coherent.

The initial electromagnetic radiation may be pulsed. For example, the initial electromagnetic radiation may be provided in pulses such as ultrashort pulses. The use of pulsed electromagnetic radiation may provide the initial electromagnetic radiation with a predetermined spectral bandwidth which may facilitate spectral dispersion of the initial electromagnetic radiation.

The pulses of electromagnetic radiation may be unchirped. The incident electromagnetic radiation and the emitted electromagnetic radiation may have different spectra and/or one or more different wavelengths.

The incident electromagnetic radiation may comprise light, for example infrared, visible or UV light.

The emitted electromagnetic radiation may comprise light, for example infrared, visible or UV light.

The emitted electromagnetic radiation may comprise THz radiation.

The incident electromagnetic radiation may be configured for two-photon excitation of the object. For example, the incident electromagnetic radiation may include an appropriate wavelength or range of wavelengths for two-photon excitation of the object. The incident electromagnetic radiation may include a wavelength in the range of 700 nm to 950 nm.

The incident electromagnetic radiation may be configured for three-photon excitation of the object. For example, the incident electromagnetic radiation may include an appropriate wavelength or range of wavelengths for three-photon excitation of object. The incident electromagnetic radiation may include a wavelength in the range of 1,300 nm to 1,700 nm.

The emitted electromagnetic radiation may be generated by the object as a result of a non-linear optical interaction between the incident electromagnetic radiation and the object.

The emitted electromagnetic radiation may comprise a harmonic of the incident electromagnetic radiation, such as a second harmonic of the incident electromagnetic radiation or a third harmonic of the incident electromagnetic radiation.

The emitted electromagnetic radiation may be generated by the object as a result of inelastic scattering of the incident electromagnetic radiation in the object.

The emitted electromagnetic radiation may be generated by the object as a result of Raman scattering of the incident electromagnetic radiation in the object.

The emitted electromagnetic radiation may be generated by the object as a result of coherent or stimulated Raman scattering of the incident electromagnetic radiation in the object.

The emitted electromagnetic radiation may be generated by the object as a result of Coherent Anti-Stokes Raman Scattering (CARS) in the object.

The incident electromagnetic radiation may comprise a stream of pulses of electromagnetic radiation.

Each pulse of the incident electromagnetic radiation may have a duration of 1 ps or less, 500 fs or less, 100-200 fs, or 10-100 fs.

The incident electromagnetic radiation may have an average power in the range 100 mW-1,000 mW, 10 mW-100 mW or 1 mW-10 mW.

1. A method for use in imaging an object through a scattering medium, the method comprising:
illuminating the object sequentially point-by-point through the scattering medium with incident electromagnetic radiation propagating along an illumination direction so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination direction so as to form spectrally dispersed electromagnetic radiation and by spatially focusing the spectrally dispersed electromagnetic radiation through the scattering medium to the object;
measuring, for each illuminated point of the object, a corresponding value representative of a quantity of at least a portion of the corresponding emitted electromagnetic radiation; and
using, for each illuminated point of the object, position information for the illuminated point and the corresponding measured value to determine an image of the object.

2. The method of claim 1, comprising:
spectrally dispersing the initial electromagnetic radiation in the direction transverse to the illumination direction so as to form spectrally dispersed electromagnetic radiation; and
spatially focusing the spectrally dispersed electromagnetic radiation though the scattering medium to form the incident electromagnetic radiation in the object.

3. The method of claim 1, wherein measuring, for each illuminated point of the object, the corresponding value representative of the quantity of at least a portion of the emitted electromagnetic radiation comprises:
using a single pixel detector to measure the power or the intensity of the emitted electromagnetic radiation which is incident on the single pixel detector; or
measuring, for each illuminated point of the object, the power or the intensity of the emitted electromagnetic radiation incident on a single pixel of a multi-pixel detector such as an image sensor; or
spatially integrating, for each illuminated point of the object, the power or the intensity of the emitted electromagnetic radiation incident on a plurality of the pixels of the multi-pixel detector.

4. (canceled)

5. The method of claim 1, comprising:
illuminating one side of the object sequentially point-by-point through the scattering medium with the incident electromagnetic radiation; and
measuring, for each illuminated point of the object, the corresponding value representative of a quantity of at least a portion of the emitted electromagnetic radiation emitted from the same side of the object through the same scattering medium; or
the method comprising:
using a lens to illuminate the object with the incident electromagnetic radiation; and
using the same lens to collect at least a portion of the emitted electromagnetic radiation.

6. (canceled)

7. The method of claim 1, wherein illuminating the object sequentially point-by-point through the scattering medium with the incident electromagnetic radiation comprises moving the incident electromagnetic radiation relative to the object and the scattering medium.

8. The method of claim 7, wherein moving the incident electromagnetic radiation relative to the object and the scattering medium comprises:
sequentially spectrally dispersing different portions of a beam of initial electromagnetic radiation so as to sequentially form a plurality of corresponding spectrally dispersed beams of electromagnetic radiation; and
sequentially spatially focusing each spectrally dispersed beam of electromagnetic radiation to a corresponding point of the object through the scattering medium.

9. The method of claim 7, wherein moving the incident electromagnetic radiation relative to the object and the scattering medium comprises:
sequentially directing the spectrally dispersed beam of electromagnetic radiation in a plurality of different directions so as to sequentially form a plurality of corresponding spectrally dispersed beams of electromagnetic radiation; and
sequentially spatially focusing each spectrally dispersed beam of electromagnetic radiation to a corresponding point of the object through the scattering medium.

10. The method of claim 1, wherein illuminating the object sequentially point-by-point through the scattering medium with the incident electromagnetic radiation comprises moving the object and the scattering medium together relative to the incident electromagnetic radiation.

11. A system for use in imaging an object through a scattering medium, the system comprising:
an illumination arrangement for illuminating the object sequentially point-by-point through the scattering medium with incident electromagnetic radiation propagating along an illumination direction so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination direction so as to form spectrally dispersed electromagnetic radiation and by spatially focusing the spectrally dispersed electromagnetic radiation through the scattering medium to the object;
a detection arrangement for measuring, for each illuminated point of the object, a corresponding value representative of a quantity of at least a portion of the corresponding emitted electromagnetic radiation; and
a processing resource configured to use, for each illuminated point of the object, position information for the illuminated point and the corresponding measured value to determine an image of the object.

12. The system of claim 11, wherein the illumination arrangement comprises:
a spectrally dispersive element such as a diffraction grating for spectrally dispersing the initial electromagnetic radiation in the direction transverse to the illumination direction so as to form spectrally dispersed electromagnetic radiation; and
a spatial focusing arrangement located after the spectrally dispersive element for spatially focusing the spectrally dispersed electromagnetic radiation through the scattering medium to form the incident electromagnetic radiation in the object.

13. The system of claim 11, wherein the detection arrangement comprises:
a single pixel detector for measuring the power or intensity of the emitted electromagnetic radiation incident on the single pixel detector; or
wherein the detection arrangement comprises a multi-pixel detector having a plurality of pixels, for example an image sensor, wherein the detection arrangement is configured to:
measure the power or the intensity of the emitted electromagnetic radiation incident on a single pixel of the multi-pixel detector, or
spatially integrate the power or the intensity of the emitted electromagnetic radiation incident on a plurality of the pixels of the multi-pixel detector.

14. (canceled)

15. The system of claim 12, comprising a spatial modulation arrangement located before the spectrally dispersive element for sequentially directing different portions of a beam of the initial electromagnetic radiation onto the spectrally dispersive element so as to sequentially form a plurality of corresponding spectrally dispersed beams of electromagnetic radiation, wherein the spatial focusing arrangement is configured to sequentially couple each spectrally dispersed beam of electromagnetic radiation to the object so as to illuminate a corresponding point of the object through the scattering medium with the incident electromagnetic radiation.

16. The system of claim 15, wherein the spatial modulation arrangement comprises a diffractive spatial modulation arrangement such as a spatial light modulator or the spatial modulation arrangement comprises a digital micro-mirror device.

17. The system of claim 12, wherein the illumination arrangement comprises a beam scanning arrangement located after the spectrally dispersive element for sequentially directing a beam of spectrally dispersed electromagnetic radiation in a plurality of different directions so as to sequentially form a plurality of corresponding spectrally dispersed beams of electromagnetic radiation, and wherein the spatial focusing arrangement is configured to sequentially spatially focus each spectrally dispersed beam of electromagnetic radiation to the object so as to illuminate a corresponding point of the object through the scattering medium with the incident electromagnetic radiation.

18. The system of claim 11, comprising a translation stage for moving the object and the scattering medium together relative to the incident electromagnetic radiation.

19. The system of claim 11, wherein the illumination arrangement is configured to illuminate one side of the object through the scattering medium, and wherein the detection arrangement is configured to measure the value representative of the quantity of at least a portion of the emitted electromagnetic radiation emitted from the same side of the object through the same scattering medium; or
wherein the system comprises a lens, such as a microscope objective, configured to illuminate the object, wherein the same lens is configured to collect at least a portion of the emitted electromagnetic radiation emitted from the object through the same scattering medium.

20. (canceled)

21. The system of claim 11, wherein the illumination arrangement comprises a source of electromagnetic radiation for generating the initial electromagnetic radiation, wherein at least one of:
the source of electromagnetic radiation is coherent;
the source of electromagnetic radiation is tunable;
the source of electromagnetic radiation comprises a laser;
the source of electromagnetic radiation comprises an optical parametric oscillator (OPO); and
the source of electromagnetic radiation is configured to generate pulses of electromagnetic radiation, wherein the pulses of electromagnetic radiation are ultrashort, unchirped, and/or transform-limited.

22. The system of claim 11, wherein at least one of:
the system is configured for microscopy;
the system is configured for use with a microscope; and
the system comprises a microscope.

23. The method of claim 1, wherein the object is formed separately from the scattering medium or wherein the object comprises a sub-surface region of a sample and the scattering medium comprises a scattering surface region of the same sample.

24. The method of claim 1, wherein the emitted electromagnetic radiation comprises fluorescence generated by the object as a result of excitation of the object by the temporally focused electromagnetic radiation or wherein the temporally focused electromagnetic radiation is configured for multi-photon excitation of the object such as two-photon or three-photon excitation of the object.

25. (canceled)

26. The system of claim 11, wherein the object is formed separately from the scattering medium or wherein the object comprises a sub-surface region of a sample and the scattering medium comprises a scattering surface region of the same sample.

27. The system of claim 11, wherein the emitted electromagnetic radiation comprises fluorescence generated by the object as a result of excitation of the object by the temporally focused electromagnetic radiation or wherein the temporally focused electromagnetic radiation is configured for multi-photon excitation of the object such as two-photon or three-photon excitation of the object.
